(19) United States
(12) Patent Application Publication
(10) Pub. No.: US 2011/0048674 A1
(43) Pub. Date: Mar. 3, 2011

(54) HOLDING MODULE FOR HEAT EXCHANGER TUBES

(75) Inventor: Johann Justl, Regensburg (DE)

(73) Assignee: KRONES AG, Neutraubling (DE)

(21) Appl. No.: 12/870,024

(22) Filed: Aug. 27, 2010

(30) Foreign Application Priority Data
Sep. 2, 2009 (DE) 102009039816.3

(51) Int. Cl. F28F 9/013; B23P 19/04; A47B 81/00

(52) U.S. Cl. 165/67; 29/428; 211/49.1

(57) ABSTRACT

A holding module for heat exchanger tubes, a rack with such holding modules as well as a method for setting up such a rack, where the holding module includes a lower module half which comprises several recesses into each of which one heat exchanger tube can be placed, an upper holding module half which comprises several recesses and which can be placed onto the lower holding module half such that its recesses are lying opposite to the recesses of the lower holding module half, such that the heat exchanger tubes are held in the recesses. Further, at least one connecting element connects the upper and the lower holding module halves.

### CROSS-REFERENCE TO RELATED APPLICATION

The present application claims the benefit of priority of German Application No. 102009039816.3, filed Sep. 2, 2009. The entire text of the priority application is incorporated herein by reference in its entirety.

### FIELD OF THE DISCLOSURE

The disclosure relates to a holding module for heat exchanger tubes, a rack for heat exchanger tubes with several holding modules as well as a method for setting up a rack for heat exchanger tubes.

### BACKGROUND

The use of heat exchangers, in particular tubular heat exchangers, for transmitting thermal energy from one medium to a second medium is widely spread. Depending on application, several tubular heat exchangers are combined in individual sections. The tubular heat exchangers e.g. comprise, as will be illustrated more in detail hereinafter, a heat exchanger tube, i.e. a casing tube in which a plurality of internal tubes is arranged, at least, however, one internal tube. The heat exchanger tubes are held by means of frames and shelf racks.

The conventional racks, however, require a lot of space, and the manufacture of such racks and their equipment are moreover complex and expensive. The size of the known racks is fixed and they cannot be flexibly extended.

### SUMMARY OF THE DISCLOSURE

Starting from this situation, an aspect underlying the present disclosure is to provide a device and a method by means of which heat exchanger tubes can be held in a simpler, more space-saving and cheaper manner, where the device can be in particular flexibly extended.

According to the present disclosure, individual holding modules for the heat exchanger tubes are used for the modularly assembled rack. A holding module comprises a lower module half with several recesses into each of which one heat exchanger tube can be placed, as well as an upper holding module half which also comprises several recesses and which can be placed onto the lower holding module half, such that its recesses are lying opposite to the recesses of the lower holding module half, such that the heat exchanger tubes are held in the recesses.

A connecting element connects the upper and the lower halves. Thus, the heat exchanger tube can be simply placed into the holding module, and the second half can then be placed on top. The rack is assembled in steps together with the piling up of the heat exchanger tubes. Level by level is piled up until a certain rack height is reached.

According to the present disclosure, a very compact construction can be achieved. By the modular structure, the height can be flexibly adapted to certain requirements. The height of the system can also be subsequently flexibly extended. The system can be extended as desired. The rack according to the disclosure is clearly less expensive than the known frame racks. The assembly of the individual modules is also very simple and quick. Moreover, an improved design results.

Advantageously, the connecting element which connects the upper and the lower holding module half is a plug-in element that can be plugged onto the lower holding module half, while the upper holding module half is plugged onto the plug-in element. Such a connecting element is inexpensive and moreover permits an easy assembly.

The plug-in element preferably extends in the longitudinal direction of the heat exchanger tubes and provides a stable connection.

Advantageously, the upper and lower holding module halves are constructed in the same way. Thus, the complete holding module can be manufactured very inexpensively.

According to a preferred embodiment of the holding module, the upper and/or lower holding module half is embodied such that it comprises an essentially U-shaped cross-section with two opposite side walls and an intermediate bottom, the recesses being embodied in the side walls. Thus, each module half comprises two support surfaces for the heat exchanger tube and permits a good support for the heat exchanger tube. By the U-shaped embodiment, the weight of the holding module can be essentially reduced.

The plug-in element can be embodied e.g. such that it comprises at least two upper and/or at least two lower openings into which the side walls of the upper or the lower holding module half can be inserted, or else the lower holding module half and/or the upper holding module half is embodied such that they comprise openings in the side walls into which the plug-in element can be inserted.

A rack for the heat exchanger tubes comprises at least one first and one second unit in which several modules each are arranged one upon the other, where then the heat exchanger tubes arranged in parallel to each other are held by the first and the at least second unit. Depending on the length of the tubes, a varying number of units can be employed. Equally, depending on the diameter and number of the heat exchanger tubes, each level can be differently equipped. The units do not have to be filled completely. The modules arranged one upon the other in the units can be fixed to each other by a fixing means. To fix the modules in a respective unit, the modules can comprise e.g. through openings arranged one upon the other into which a fixing rod can then be inserted from above. Thus, the individual modules arranged one upon the other remain in correct orientation with respect to each other. For even better fixing, lateral crossbars can be arranged between the holding element units for bracing.

The lowermost holding module half of each holding module unit can be firmly connected to a bottom frame. Thus, the lowermost holding module half has a stable grip and permits secure assembly of the modules to be arranged thereabove.

In the method according to the disclosure, several holding module halves spaced apart are provided (step a). Then, the heat exchanger tubes are placed into the recesses of the lower holding module halves (step b). Finally, the several upper holding module halves are placed onto the tubes, such that the recesses face the tubes and receive them (step c). A lower holding module half can then be placed again on the upper side of the now already installed upper holding module half to produce a further module (step d). Steps d, b, c can be repeated as often as desired until a desired rack height is reached.

After step a or b, the holding module halves are fixed. For this, after step a or b, at least one plug-in element can be inserted into the lower holding module half, and the upper holding module half can be placed onto the at least one plug-in element in step c. Thus, a simple self-supporting modular system is formed. The modules arranged one upon the other in one unit can then be also fixed again to each other to achieve an altogether stable system.

### BRIEF DESCRIPTION OF THE DRAWINGS

The present disclosure will be illustrated below in greater detail with reference to the following figures:

FIG. 1 shows a holding module according to the present disclosure in a perspective representation;

FIG. 2 shows a lower holding module half with inserted plug-in element in a perspective representation;

FIG. 3 schematically shows a front view of a plug-in element according to the present disclosure;

FIG. 4 shows a perspective representation of three holding modules according to the present disclosure arranged one upon the other;

FIG. 5 shows a schematic perspective representation in partial elevation of a rack according to the present disclosure, wherein the heat exchanger tubes are not represented;

FIG. 6 schematically shows an example of a heat exchanger tube;

FIG. 7 shows a rack according to the present disclosure in a perspective representation.

### DETAILED DESCRIPTION OF THE PREFERRED EMBODIMENT

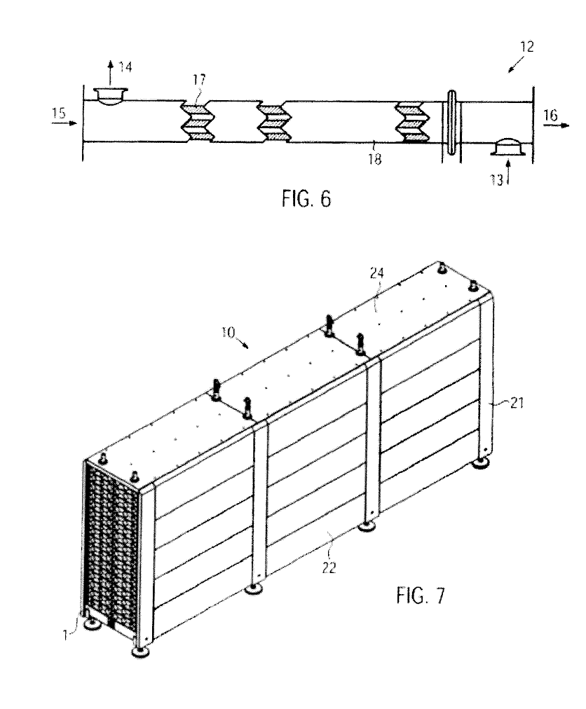

FIG. 6 shows the basic structure of a heat exchanger tube 12. The heat exchanger tube 12 here comprises a casing or external tube 18 with an inlet 13 on the secondary side and an outlet 14 on the secondary side. In the casing tube 18, several internal tubes, at least, however, one internal tube or bank of tubes 17, respectively, are arranged which comprise a corresponding inlet 15 and outlet 16 on the primary side. The individual heat exchanger tubes 12 can be interconnected in individual sections, i.e. then, for example, the outlet 16 of a first heat exchanger tube is connected to the inlet 15 of a subsequent heat exchanger tube, e.g. arranged in parallel to it, and the outlet 14 is connected to the inlet 13 of a subsequent tube. The inlets 15 and outlets 16 can be interconnected, for example, via tube bends. The outlets 14 and the inlets 13 can also be connected by corresponding tube connections.

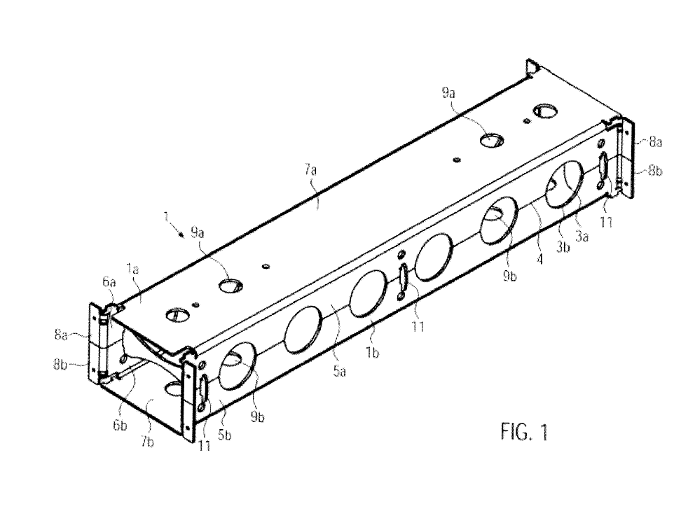

FIG. 1 shows in a perspective representation a holding module for holding several heat exchanger tubes 12 extending in parallel with respect to each other, which are not represented here for the sake of simplicity. A holding module 1 comprises a lower holding module half 1b which comprises several recesses 3b into each of which one heat exchanger tube 12 can be placed, and an upper holding module half 1a which comprises several recesses 3a and which can be placed onto the lower holding module half 1b such that the recesses 3a are lying opposite to the recesses 3b, such that the heat exchanger tube can be firmly held in the recesses 3a, b. The inner diameter of the essentially circular recess 3a, b here essentially corresponds to the outer diameter of the heat exchanger tube 12, such that the tube is held to be protected from shifting.

Normally, the holding modules are designed such that one of the units 30, 31, 32, 33 serve as fixed, and the other ones as loose bedding, so that the different thermal expansions of the individual heat exchanger tubes with respect to the rack are compensated.

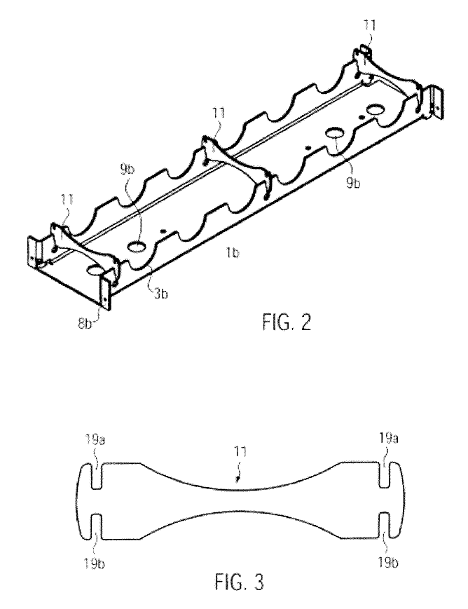

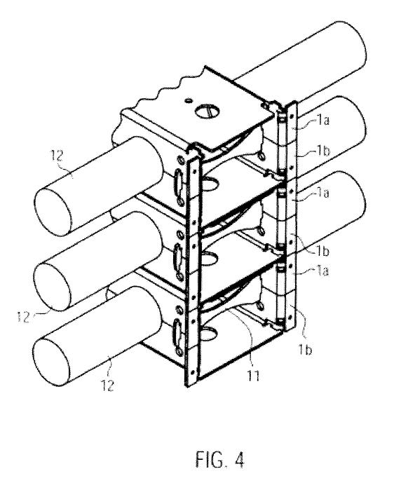

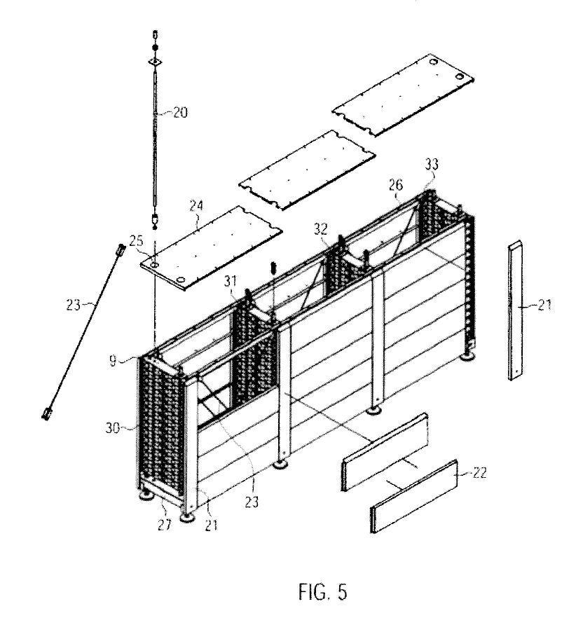

As can be taken in particular from FIG. 2, each holding module half is embodied such that it has a U-shaped cross-section, so that the holding module 1 is embodied to be hollow inside and only has a low weight. The openings 3a, b are embodied in the opposite side walls 5a, b and 6a, b of the module halves 1a, b. One bottom 7a, b each is situated between the side walls 5a, b and 6a, b. In this example, six recesses 3a, b for six heat exchanger tubes arranged in parallel to each other in one level are provided. Advantageously, approximately two to ten such openings are provided next to each other. Angles 8a, b are shaped to the front and end side of the holding module 1, so that after the set up of the individual holding modules, crossbars and/or a covering, as will be illustrated more in detail below, can be arranged. In both bottoms 7a, b, opposite openings 9a, b are provided into which a fixing rod 20 (see FIG. 5) can be inserted for fixing holding modules arranged one upon the other.

To connect the two holding module halves 1a, b with each other, a connecting element, preferably a plug-in element 11, is provided. The plug-in element can be plugged onto the lower holding module half 1b, while the holding module half 1a is plugged onto the plug-in element 1. Here, a holding module 3 comprises such plug-in elements 11. The number of plug-in elements 11 depends on the size of the holding module.

As can be in particular also taken from FIG. 2, the plug-in element extends in the longitudinal direction of the heat exchanger tubes 12. Here, the plug-in element comprises two openings 19a at the upper side and two openings 19b at the bottom side. The side walls 6a, b and 5a, b can be inserted into these openings. As an alternative to this, the lower holding module half 1b and the upper holding module half 1a can also comprise openings in the side walls into which the plug-in element 11, which then does not require any corresponding openings, can be inserted. Thus, a secure grip of the two holding module halves is ensured. Several holding modules 1 can be arranged one upon the other, as can be taken from FIG. 4.

FIG. 4 shows, for example, three holding modules 1 which are arranged one upon the other, where three heat exchanger tubes 12 have been inserted and the individual halves have been connected to each other by means of the plug-in elements 11 during the assembly. This results in a self-supporting unit.

In FIG. 5, a rack for heat exchanger tubes with several holding modules 1, as described above, are shown. The holding modules 1 correspond to the above described holding modules. For the sake of simplicity, the heat exchanger tubes 12 are not represented in FIG. 5. The rack comprises several units 30, 31, 32 in which several holding modules 1 are arranged one upon the other. In this embodiment, four units are provided. The heat exchanger tubes 12 arranged in parallel are held by the holding modules in the respective units 30, 31, 32, 33. The lowermost holding module half 1b of each holding module unit 30 to 33 can be firmly fixed to a frame 27 which can stand on corresponding feet. Then, so many heat module halves and heat exchanger tubes are piled up level by level until a desired height is reached. If a desired height is reached, the modules 1 arranged one upon the other of each unit can be fixed to each other by a fixing means 9, 20. For this, a through opening 9 (openings 9a, b, in the bottom of the holding module halves) is provided in each module 1, as already described above. A fixing rod 20 is pushed through the openings and for example fixed by screwing. Here, there are two fixing means 20, 9 per unit. The holding modules 1 piled one upon the other can then be braced between the units 30, 31, 32, 33, e.g. with crossbars 23. The crossbars 23 can be placed either directly at the modules (not represented), or else with frame parts 26 which are fixed between the units. In addition, side covering parts 21, 22 can be attached to the open sides of the rack. An upper covering 24 can also be arranged between the individual units. Here, the upper coverings 24, which comprise openings 25 above the corresponding openings 9, are also held by the fixing rod 20. FIG. 7 shows a rack with a covering.

The system according to the disclosure brings about the advantage that the number of heat exchanger tubes arranged in one level can be varied, i.e. that for example not all recesses must be occupied by tubes. The number of modules or tubes, respectively, arranged one upon the other can also be simply varied by stacking the desired number of modules one upon the other.

At the front sides of the rack, the heat exchanger tubes 12 project (not represented) and can be connected to each other via corresponding tube bends or connecting elements depending on the interconnection, as was also described in connection with FIG. 6. Here, they can be connected vertically as well as horizontally. The center distance of the openings is identical in identical units.

In the method according to the disclosure for setting up the rack shown in FIG. 5, first in a step a, several lower holding module halves 1b that are spaced apart are provided. Here, the holding module halves 1b are fixed to the frame 27. In a next step b, the heat exchanger tubes 12 are placed into the lowermost heat exchanger half 1b of each unit 30, 31, 32, 33 (step b). In each unit 30, 31, 32, 33, an upper holding module half 1a is now placed onto the tubes, such that the recesses 3a are facing the tubes 12 and receive and hold the same. After step a or b, here the plug-in element 11 is inserted into the lower holding module half 1b, the upper holding module half 1a being plugged into the plug-in element 11 in step c.

Then, a lower holding module half 1b of a further module can be placed onto the upper side of the upper holding module half 1a, so that the bottom 7b comes to lie on the bottom 7a.

Steps a, b, c can be repeated as often as desired until a predetermined rack height is reached. Then, the modules arranged one upon the other in the individual units 30, 31, 32, 33, can be fixed to each other via the fixing means 20, 9, as illustrated before, by passing the rod 20 through the openings 9 and screwing it down. Finally, cross bracings can be arranged and the longitudinal covering elements 21, the upper covering elements 24, and the lateral covering elements 22 can be arranged as desired. Frame parts 26 can be arranged between the individual units.

In this manner, the heat exchanger tubes can be very easily mounted. An attractive design results. The height of the modular structure can be flexibly extended. The compact design is extremely space-saving.

1. Holding module for heat exchanger tubes, comprising:
a lower holding module half which comprises several recesses into each of which one heat exchanger tube can be placed,
an upper holding module half which comprises several recesses (3a) and can be placed onto the lower holding module half such that its recesses are lying opposite to the recesses of the lower holding module half, such that the heat exchanger tubes are held in the recesses, and
at least one connecting element which connects the upper and the lower holding module half.

2. Holding module according to claim 1, wherein the connecting element is a plug-in element which can be plugged onto the lower holding module half, where the upper holding module half is plugged onto the plug-in element.

3. Holding module according to claim 2, wherein the plug-in element extends in the longitudinal direction of the heat exchanger tubes.

4. Holding module according to claim 1, wherein the upper and the lower holding module half are constructed in the same way.

5. Holding module according to claim 1, wherein the upper and/or lower holding module half comprises a U-shaped cross-section with two opposite side walls and an intermediate bottom, where the recesses are embodied in the side walls.

6. Holding module according to at least claim 3, wherein the plug-in element comprises at least two upper and/or at least two lower openings into which the side walls of the upper or lower holding module half can be inserted, or the lower holding module half and/or the upper holding module half comprise openings in the side walls into which the plug-in element can be inserted.

7. Rack for heat exchanger tubes (12) with a plurality holding modules according to claim 1, comprising:
a first unit in which several modules are arranged one upon the other, and
at least one second unit in which several modules are arranged one upon the other, wherein the heat exchanger tubes are each held by the modules of the first and the at least one second unit.

8. Rack according to claim 7, wherein the modules arranged one upon the other are fixed in a respective unit by a fixing means.

9. Rack according to claim 8, wherein for fixing the modules of a respective unit, the modules comprise through openings arranged one upon the other into which a fixing rod can be inserted.

10. Rack according to claim 7, and wherein lateral crossbars are arranged between the units.

11. Rack according to claim 7, wherein the lowermost holding module half of each holding module unit is firmly connected to a floor frame.

12. Method for setting up a rack for heat exchanger tubes with a module according to claim 1, comprising:
a) providing several lower holding module halves spaced apart;
b) inserting the heat exchanger tubes into the recesses of the lower holding module half;
c) placing several upper holding module halves onto the tubes, such that the recesses are facing the tubes and receive the same, and
d) placing a lower holding module half onto the upper side of the upper holding module half,
wherein the steps d), b), c) can be repeated as often as desired until a certain rack height is reached.

13. Method according to claim 12, and fixing the holding module halves to each other.

14. Method according to claim 3, wherein after step a) or b), inserting at least one plug-in element into the lower holding module half, and plugging the upper holding module half onto the at least one plug-in element in step c).

15. Method according to claim 12, and wherein the modules arranged one upon the other in one unit are fixed to each other.
